(19) United States
(12) Patent Application Publication
(10) Pub. No.: US 2017/0235683 A1
(43) Pub. Date: Aug. 17, 2017

(54) AUTHENTICATION METHOD, AUTHENTICATION PROGRAM MEDIUM, AND INFORMATION PROCESSING APPARATUS

(71) Applicant: FUJITSU LIMITED, Kawasaki-shi (JP)

(72) Inventor: Hisanori IIJIMA, Yokohama (JP)

(73) Assignee: FUJITSU LIMITED, Kawasaki-shi (JP)

(21) Appl. No.: 15/384,845

(22) Filed: Dec. 20, 2016

(30) Foreign Application Priority Data
Feb. 16, 2016 (JP) 2016-026721

(51) Int. Cl. G06F 12/14; G06F 21/34; G06F 21/44; G06F 21/79

(52) U.S. Cl. CPC G06F 12/1425; G06F 21/79; G06F 21/34; G06F 21/44; G06F 2212/1052

(57) ABSTRACT

An information processing apparatus includes: a memory configured to store identification information on authentication data in association with location information on a slot, the authentication data being for determining a validity of a first program for initializing an extension card in the slot, and a validity of a second program which is stored in a storage coupled to the extension card and is for initializing an operating system; and a processor coupled to the memory and configured to execute a process including; identifying the authentication data using first identification information stored in the memory in association with location information on a first slot specified as chosen, and determining whether or not the first program, read from a first extension card in the first slot, and the second program, read from a first storage coupled to the first extension card, are valid using the authentication data.

### CROSS-REFERENCE TO RELATED APPLICATION

This application is based upon and claims the benefit of priority of the prior Japanese Patent Application No. 2016-026721, filed on Feb. 16, 2016, the entire contents of which are incorporated herein by reference.

### FIELD

The embodiment discussed herein is related to a system activation technique.

### BACKGROUND

In the process of activating a sever, a basic input/output system (BIOS) loads an extensible firmware interface (EFI) driver from a peripheral component interconnect (PCI) card, and initializes the PCI card using the thus-loaded EFI driver. In a case where an operating system (OS) is installed in a device (for example, a hard disk drive (HDD) or a digital versatile disc (DVD) drive) coupled to the PCI card, the OS may be activated by executing an OS loader because the OS loader is installed in the device.

As for the OS activation, the unified extensible firmware interface (UEFI) specification defines a technique termed as secure boot. In the secure boot, the validities of the EFI driver and the OS loader are checked using an authentication key stored in a non-volatile random access memory (NVRAM). The authentication key for secure boot is a public key or a hash key. The validities of digital signatures included in the EFI driver and the OS loader are checked using public keys. Otherwise, the validities of the EFI driver itself and the OS loader itself are valid is checked using hash values.

Among authentication keys used for secure boot, there is an authentication key that supports the authentication of the EFI drivers of multiple types of PCI cards and the OS loaders of multiple types of OSs. The use of that authentication key makes it possible to avoid the execution of EFI drivers and OS loaders which have been tampered with. However, if there are an EFI driver and an OS loader whose validities may be confirmed using an authentication key of such a type, the OS of a device, even albeit being a third party's one, may be activated using the EFI driver or the OS loader. Furthermore, a maintenance specialist may mistakenly activate a business OS in a case where the maintenance specialist has to activate an OS specialized for maintenance, such as a maintenance tool.

Related art are disclosed in Japanese Laid-open Patent Publication Nos. 2007-66216 and 2010-108313, and Japanese National Publication of International Patent Application No. 2007-525756. However, no conventional art has paid attention to the above problems.

Even if the EFI driver and the OS loader for the OS activation are authenticated using the authentication key for the security purpose, there is likelihood that the EFI driver and the OS loader are inevitably activated by an unwanted EFI driver and an unwanted OS loader.

An object of an aspect of the disclosure is to provide a technique for disabling a wrong device from activating an OS.

### SUMMARY

According to an aspect of the invention, an information processing apparatus includes: a memory configured to store identification information on authentication data in association with location information on a slot, the authentication data being for determining a validity of a first program for initializing an extension card in the slot, and a validity of a second program which is stored in a storage coupled to the extension card and is for initializing an operating system; and a processor coupled to the memory and configured to execute a process including; identifying the authentication data using first identification information stored in the memory in association with location information on a first slot specified as chosen, and determining whether or not the first program, read from a first extension card in the first slot, and the second program, read from a first storage coupled to the first extension card, are valid using the authentication data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a server;

FIG. 2 is a diagram illustrating a hardware configuration of an administrative controller;

FIG. 3 is a functional block diagram of the administrative controller;

FIG. 4 is a diagram illustrating an example of a device path table to be stored in a device path table storage;

FIG. 5 is a diagram illustrating an example of a hash table to be stored in a hash table storage;

FIG. 6 is a diagram illustrating a process flow for a process to be performed by the administrative controller;

FIG. 7 is a diagram illustrating an example of a screen for generating an authentication data set;

FIG. 8 is a diagram illustrating an example of a device path authentication table;

FIG. 9 is a diagram for explaining a database (DB) and a DBx to be used for general secure boot;

FIG. 10 is a diagram illustrating an example of data to be stored in an authentication data set storage;

FIG. 11 is a diagram illustrating a process flow of a process to be performed by the administrative controller:

FIG. 12 is a diagram illustrating an example of a screen for choosing a boot method;

FIG. 13 is a diagram illustrating an example of a screen for power supply control;

FIG. 14 is a diagram illustrating a process flow of a process to be performed when a user instructs power supply to be applied;

FIG. 15 is a diagram illustrating a process flow of a first authentication process;

FIG. 16 is a diagram illustrating a process flow of a second authentication process; and

FIG. 17 is a diagram for explain how to save a NVRAM area.

### DESCRIPTION OF EMBODIMENT

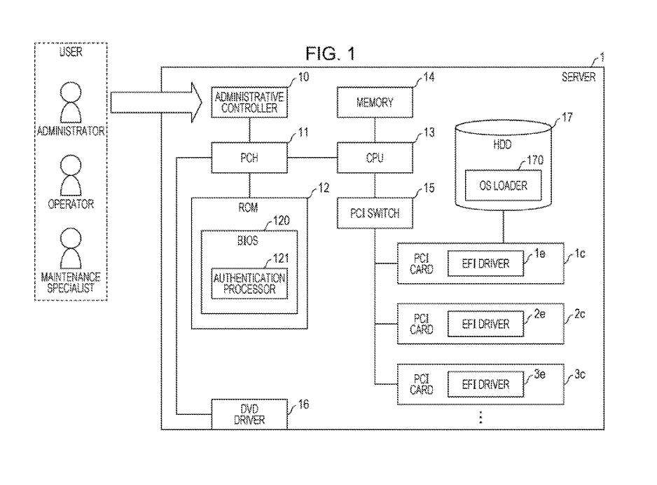

FIG. 1 illustrates a hardware configuration of a server 1 of the embodiment. An administrative controller 10 is, for example, a baseboard management controller (BMC), and performs things such as monitor of the hardware in the server 1. A platform controller hub (PCH) 11 is coupled to the administrative controller 10, and performs things such as control of input and output (I/O). A read only memory (ROM) 12 is coupled to the PCH 11, and stores a program of a BIOS 120. The BIOS 120 includes an authentication processor 121. A DVD drive 16 is coupled to the PCH 11, and read data recorded in the DVD.

A central processing unit (CPU) 13 is coupled to the PCH 11, and executes the program of the BIOS 120, EFI drivers 1e to 3e, an OS loader 170 and the like by reading them into a memory 14. The memory 14 is, for example, a main memory, and is coupled to the CPU 13. A PCI switch 15 is coupled to the CPU 13 relays data between the CPU 13 and PCI cards 1c to 3c. The PCI cards 1c to 3c are extension cards to be inserted in PCI slots. The storage of the PCI card 1c stores the EFI driver 1e; the storage of the PCI card 2c stores the EFI driver 2e; and the storage of the PCI card 3c stores the EFI driver 3e. A HDD 17 is coupled to the PCI card 1c. The HDD 17 stores the OS loader 170. Incidentally, no restriction is imposed on the number of PCI slots or the number of PCI cards. In addition, the DVD drive 16 and the HDD 17 may be external devices.

The administrative controller 10 receives inputs from users, and performs processes depending on the received inputs. The users of the embodiment include an administrator having a complete authority; an operator entitled to operate the server 1; and a maintenance specialist entitled only to check whether or not the hardware works.

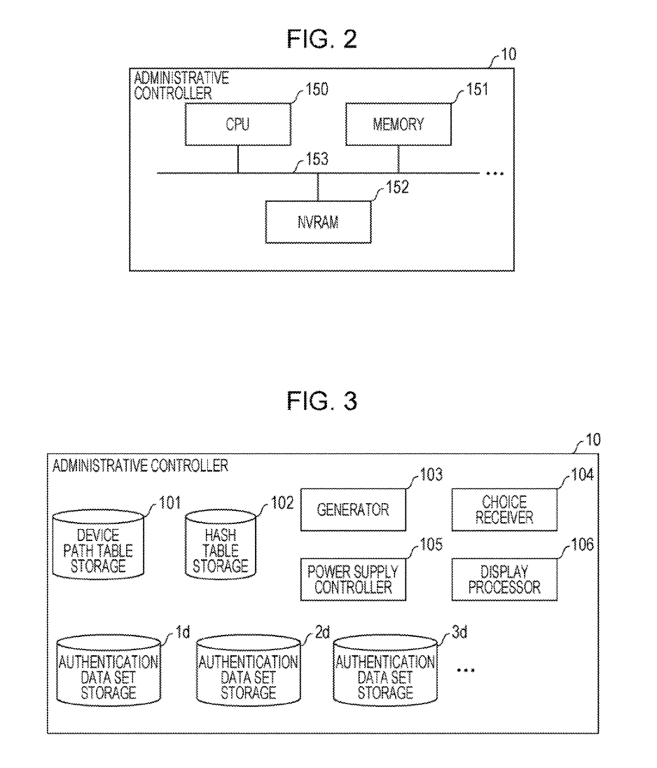

FIG. 2 illustrates a hardware configuration of the administrative controller 10. The administrative controller 10 includes a CPU 150, a memory 151 for example serving as a main storage, a NVRAM 152, and a bus 153. The CPU 150, the memory 151, and the NVRAM 152 are coupled together through the bus 153.

FIG. 3 illustrates a functional block diagram of the administrative controller 10. The administrative controller 10 includes a device path table storage 101, a hash table storage 102, a generator 103, a choice receiver 104, a power supply controller 105, a display processor 106, and authentication data set storages 1d to 3d. The generator 103, the choice receiver 104, the power supply controller 105, and the display processor 106 are implemented when the CPU 150 executes the corresponding programs by loading them into the memory 151. The device path table storage 101, the hash table storage 102, and the authentication data set storage 1d to 3d are set on the NVRAM 152, for example. Incidentally, although the number of the authentication data set storages illustrated in FIG. 3 is three, no restriction is imposed on the number.

The generator 103 performs a process of generating authentication data sets. The choice receiver 104 performs a process of receiving a choice of an authentication data set to be used for the system activation. The power supply controller 105 performs a process of controlling application of power supply to the system. The display processor 106 performs a process of displaying data on a screen on a display device coupled to the server 1.

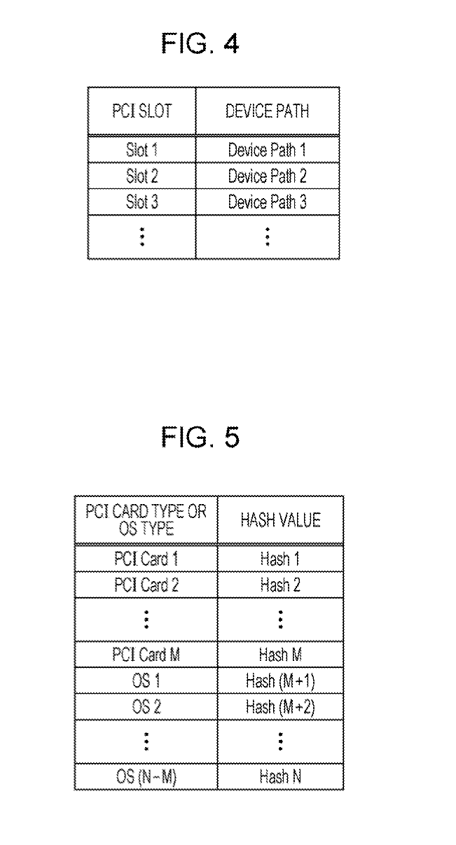

FIG. 4 illustrates an example of a device path table to be stored in the device path table storage 10. In the example illustrated in FIG. 4, the device path table storage 10 stores identification information on the PCI slots into which to load the PCI cards, and device paths. Each device path is information on a physical location of the corresponding device (PCI slot in this case), and is defined by the UEFI.

FIG. 5 illustrates an example of a hash table to be stored in the hash table storage 102. In the example illustrated in FIG. 5, the hash table storage 102 stores information on PCI card types or OS types, and hash values. For example, a hash value “Hash 1” is used for determining the validity of the EFI driver of a PCI card whose type is “PCI Card 1”.

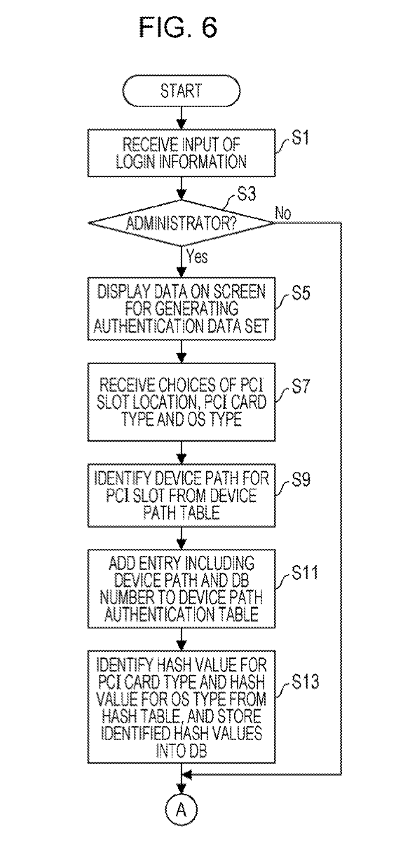

Next, using FIGS. 6 to 16, descriptions will be provided for the processes to be performed by the server 1.

To begin with, the generator 103 of the administrative controller 10 receives an input of login information from a user (step S1 in FIG. 6). The login information includes user identifier (ID) and password. Because the administrative controller 10 possesses information on the association between user IDs and user types, the reception of an input of information enables the administrative controller 10 to identify the user type of the corresponding user.

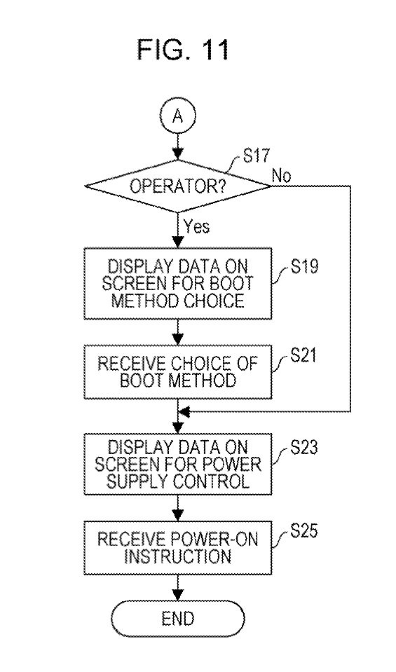

Once the user having inputted the login information succeeds in the login, the generator 103 determines whether or not the user is the administrator (step S3). If the user is not the administrator (step S3, No), the process proceeds to a process in step S17 in FIG. 11 since the user is the operator or the maintenance specialist and is not entitled to generate any authentication data set.

On the other hand, if the user having inputted the login information is the administrator (step S3, Yes), the generator 103 outputs data on a screen for generating an authentication data set to the display processor 106. In response to this, the display processor 106 displays the data on the screen for generating the authentication data set on the display device (step S5).

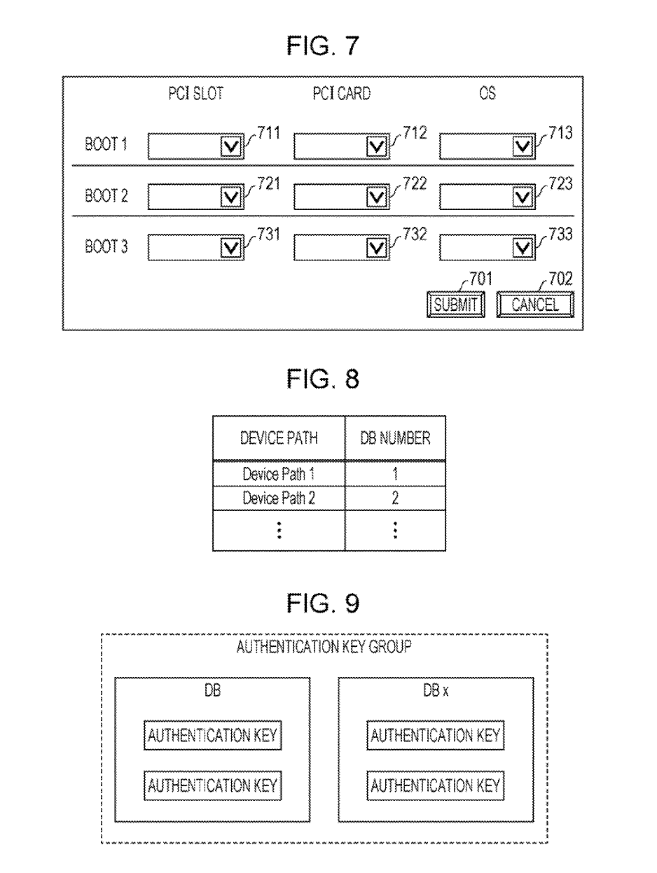

FIG. 7 illustrates an example of the screen for generating the authentication data set. In the example in FIG. 7, as for a boot 1, a pulldown menu 711 for choosing a PCI slot, a pulldown menu 712 for choosing a PCI card type, and pulldown menu 713 for choosing an OS type is display on the display device; as for a boot 2, a pulldown menu 721 for choosing a PCI slot, a pulldown menu 722 for choosing a PCI card type, and pulldown menu 723 for choosing an OS type is display on the display device; as for a boot 3, a pulldown menu 731 for choosing a PCI slot, a pulldown menu 732 for choosing a PCI card type, and pulldown menu 733 for choosing an OS type is display on the display device. The list of each of the pulldown menus 711, 721, 731 displays the identification information on the slots which is stored in the device path table storage 101. The list of each of the pulldown menus 712, 722, 732 displays the information on the PCI card types which is stored in the hash table storage 102. The list of each of the pulldown menus 713, 723, 733 displays the information on the OS types which is stored in the hash table storage 102. Once the user clicks a submit button 701 using a mouse, an authentication data set is generated based on the contents specified by the user. When the user clicks a cancel button 702 using the mouse, no authentication data set is generated.

Although the user is allowed to choose all the methods respectively corresponding to boot 1, 2, 3 in the example in FIG. 7, the user does not have to choose all the three boot methods, and may choose only the method corresponding to boot 1 for example. In a case where for example, the user chooses all the methods corresponding to boot 1, 2, 3, boot is tried according to the priority which the user selects using the BIOS menu screen.

Returning to the descriptions using FIG. 6, once the user clicks the submit button 701, the generator 103 receives information specifying the chosen PCI slot, PCI card type, and OS type from the user (step S7).

The generator 103 identifies the device path for the chosen PCI slot from the device path table (step S9). In a case where the user chooses multiple boot methods, this step is performed for each boot method.

The generator 103 adds an entry including the device path identified in step S9 and a newly-assigned DB number to a device path authentication table (step S11). In the case where the use chooses multiple boot methods, the entry for each boot method is stored in the same device path authentication table. The device path authentication table is stored into a newly-generated authentication data set storage.

FIG. 8 illustrates an example of the device path authentication table. In the example in FIG. 8, the device path authentication table stores device paths, and DB numbers respectively representing the numbers of the DBs storing the authentication keys to be used for the authentication.

The generator 130 identifies the hash vale for the chosen PCI card type and the hash value for the chosen OS type from the hash table storage 102. Thereafter, the generator 130 stores the identified hash values into the DB with the DB number newly assigned in step S11 (step S13). In the case where the user chooses multiple boot methods, the hash values identified for one boot method are stored into one DB which is different from that which stores the hash values identified for the other boot method. The DB is provided to the authentication data set storage storing the device path authentication table. The process proceeds to a process in step S17 in FIG. 11 via a terminal A.

Using FIG. 9, descriptions will be provided for a DB and a DBx to be used in a general secure boot. When secure boot is enabled, no activation is permitted in a case where the authentication may not be performed using the authentication keys stored in the DB, and in a case where the authentication may be performed using the authentication keys stored in the DBx. On the other hand, the authentication is permitted in a case where the authentication may not be performed using the authentication keys stored in the DBx, and in a case where the authentication may be performed using the authentication keys stored in the DB. In the embodiment, multiple authentication keys, including the authentication keys stored in the DB and authentication keys stored in the DBx, are referred to as an authentication key group.

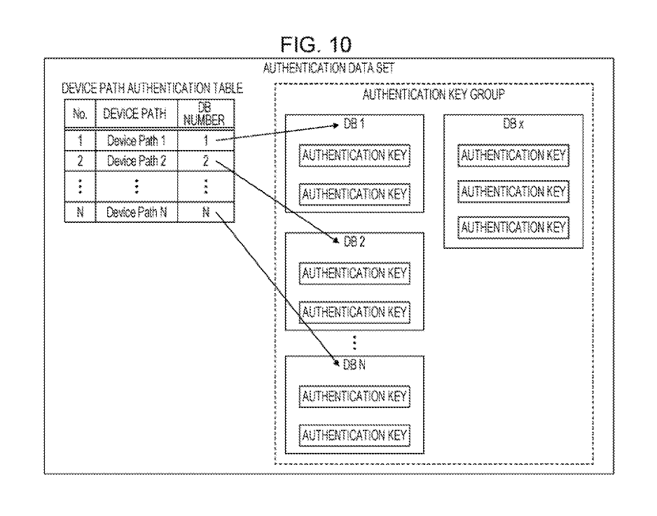

FIG. 10 illustrates an example of data to be stored in the authentication data set storages 1d to 3d. In the example in FIG. 10, one authentication data set stores the device path authentication table and the authentication key group. A DB to be used for the authentication is identified using the corresponding DB number stored in the device path authentication table. In the embodiment, each DB stores two authentication keys; one is a hash value for the chosen PCI card type; and the other is a hash value for the chosen OS type. Authentication keys stored in the DBx are hash values as well. The DBs are associated with the respective booth methods.

Proceeding to descriptions using FIG. 11, the choice receiver 104 determines whether or not the user having inputted the login information is the operator (step S17). If the user is not the operator (step S17, No), the process proceeds to a process in step S23 since the user is the maintenance specialist and is not entitled to choose any boot method.

On the other hand, if the user having inputted the login information is the operator (step S17, Yes), the choice receiver 104 outputs data on a screen for a boot method choice on the display processor 106. In response to this, the display processor 106 displays the data on the screen for the boot method choice (step S19).

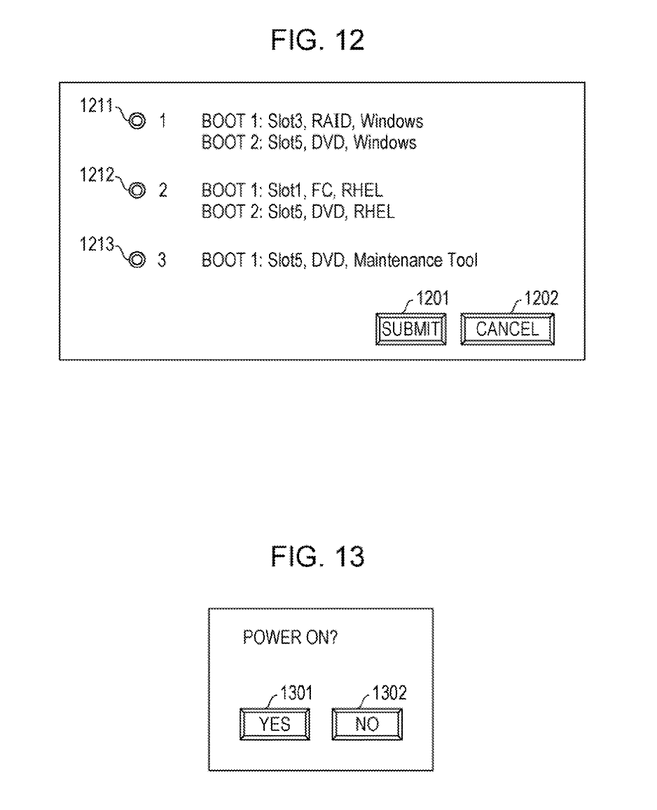

FIG. 12 illustrates an example of the screen for the boot method choice. In the example in FIG. 12, the user may make a choice from the boot methods using radio buttons 1211 to 1213. For example, in a case where the user selects the radio button 1211, boot is executed using a method for boot 1 or 2 according to the priority which the user selects using the BIOS menu screen. Once the user clicks a submit button 1201 using the mouse, boot is executed using the chosen boot method. When the user clicks a cancel button 1202 using the mouse, no boot method is chosen. In that case, boot may be executed using a beforehand-determined boot method.

Returning to the descriptions using FIG. 11, once the user clicks the submit button 1201, the choice receiver 104 receives information specifying a chosen boot method from the user (step S21).

The power supply controller 105 instructs the display processor 106 to display data on a screen for power supply control. In response to this, the display processor 106 displays the data on the screen for power supply control (step S23). FIG. 13 illustrates an example of the screen for power supply control. The example in FIG. 13 illustrates a button 1301 to be pressed to apply power supply, and a button 1302 to be pressed to apply no power supply.

The power supply controller 105 receives an input of a power-on instruction from the user who has checked the screen for power supply control (step S25). With this, the processes are completed.

The foregoing processes make it possible to restrict users' operations according to the user types, and accordingly to inhibit the activation of the system using wrong activation methods. Furthermore, the foregoing processes make it possible for the users to make a choice from the boot methods prepared in advance, and accordingly to make the users less likely to mistakenly select a wrong activation method than a procedure in which the users have to choose a boot method from the beginning at any time.

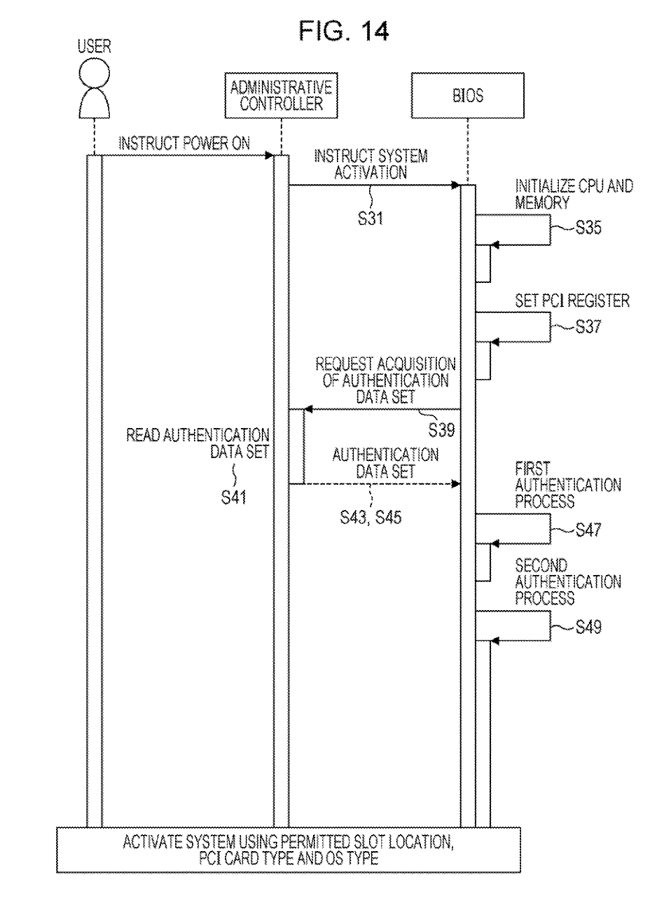

Next, using FIGS. 14 to 16, descriptions will be provided for a process to be performed when the user instructs the power supply to be applied.

To begin with, upon receipt of the power-on instruction, the administrative controller 10 outputs a system activation instruction to the BIOS 120 (step S31 in FIG. 14).

The BIOS 120 receives the system activation instruction from the administrative controller 10 (step S33).

The BIOS 120 initializes the CPU 13 and the memory 14 (step S35), and initializes PCI registers on the PCI cards 1c to 3c (step S37).

The BIOS 120 outputs an acquisition request for requesting acquisition of an authentication data set to the administrative controller 10 (step S39).

Upon receipt of the acquisition request from the BIOS 120, the choice receiver 104 of the administrative controller 10 reads the authentication data set associated with the boot method chosen in step S21 or the beforehand-determined boot method (for example, a boot method for activating a specialized OS, such as a maintenance tool) from the corresponding one of the authentication data set storages 1d to 3d (step S41).

The choice receiver 104 outputs the authentication data set read in step S41 to the BIOS 120 (step S43).

The authentication processor 121 of the BIOS 120 receives the authentication data set from the administrative controller 10 (step S45).

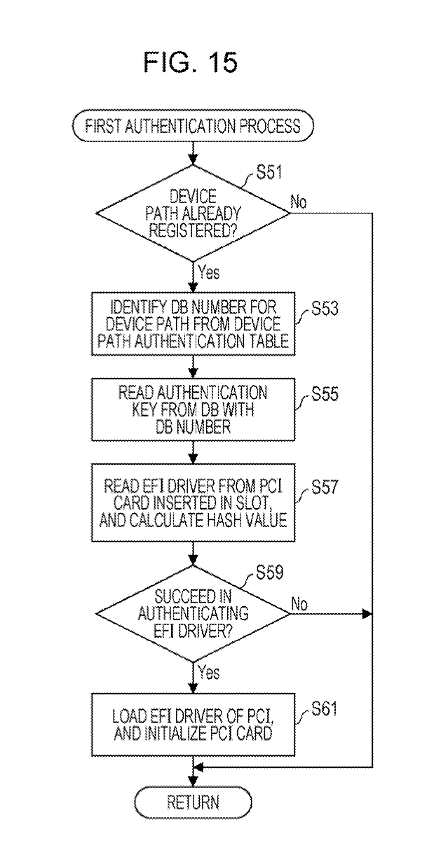

The authentication processor 121 performs a first authentication process (step S47). The first authentication process will be discussed using FIG. 15.

To begin with, the authentication processor 121 determines whether or not the device path of the PCI slot to which a boot disk (the HDD 17 in the example in FIG. 1) is coupled (hereinafter referred to as an “object device path”) has been registered in the device path authentication table included in the authentication data set received in step S45 (step S51 in FIG. 15).

If the object device path has not been registered in the device path authentication table included in the authentication data set (step S51, No), the authentication processor 121 returns to the process of the caller.

On the other hand, if the object device path has been registered in the device path authentication table included in the authentication data set (step S51, Yes), the authentication processor 121 identifies the DB number for the object device path from the device path authentication table (step S53).

The authentication processor 121 reads the authentication key (the hash value in the embodiment) from the DB with the DB number identified in step S53 (step S55).

The authentication processor 121 reads the EFI driver from the PCI card inserted in the PCI slot to which the boot disk is coupled, and calculates the hash value according to a predetermined algorithm (step S57).

The authentication processor 121 determined whether or not the EFI driver has been successfully authenticated depending on whether or not the hash value read in step S55 is equal to the hash value calculated in step S57 (step S59).

If the EFI driver has not been successfully authenticated (the EFI driver is not valid) (step S59, No), the authentication processor 121 returns to the process of the caller. If the EFI driver has been successfully authenticated (the EFI driver is valid) (step S59, Yes), the authentication processor 121 loads the EFI driver read from the PCI card into the memory 14, and initializes the PCI card (step S61). Thereafter, the authentication processor 121 returns to the process of the caller.

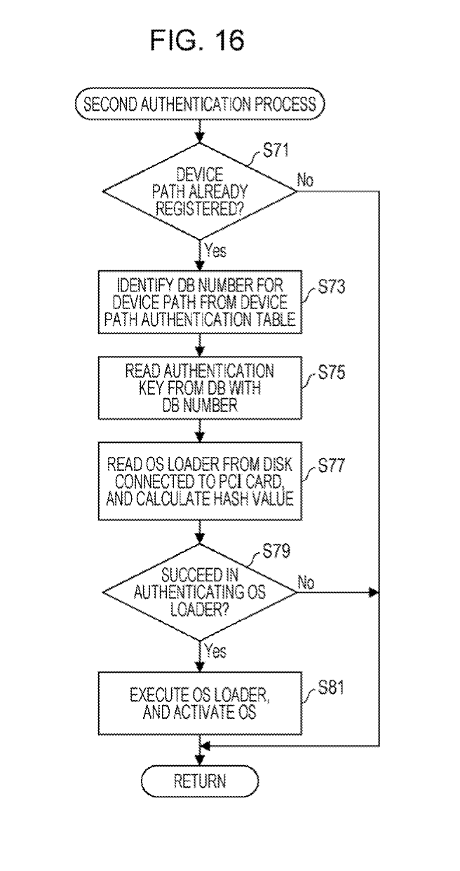

Returning to the descriptions using FIG. 14, once the authentication processor 121 succeeds in performing the first authentication process, the authentication processor 121 performs the second authentication process (step S49). Using FIG. 16, descriptions will be provided for the second authentication process.

To begin with, the authentication processor 121 determines whether or not the device path of the PCI slot to which the boot disk is coupled (hereinafter referred to as an “object device path”) has been registered in the device path authentication table included in the authentication data set received in step S45 (step S71 in FIG. 16).

If the object device path has not been registered in the device path authentication table included in the authentication data set (step S71, No), the authentication processor 121 returns to the process of the caller.

On the other hand, if the object device path has been registered in the device path authentication table included in the authentication data set (step S71, Yes), the authentication processor 121 identifies the DB number for the object device path from the device path authentication table (step S73).

The authentication processor 121 reads the authentication key (the hash value in the embodiment) from the DB with the DB number identified in step S73 (step S75).

The authentication processor 121 reads the OS loader 170 from the boot disk, and calculates the hash value according to a predetermined algorithm (step S77).

The authentication processor 121 determined whether or not the OS loader 170 has been successfully authenticated depending on whether or not the hash value read in step S75 is equal to the hash value calculated in step S77 (step S79).

If the OS loader 170 has not been successfully authenticated (the OS loader 170 is not valid) (step S79, No), the authentication processor 121 returns to the process of the caller. If the OS loader 170 has been successfully authenticated (the OS loader 170 is valid) (step S79, Yes), the authentication processor 121 loads the OS loader 170 read from the boot disk into the memory 14, and executes the OS loader 170 (step S81). Thereby, the authentication processor 121 activates the OS. Thereafter, the authentication processor 121 returns to the process of the caller.

In a case where multiple DBs are included in the selected authentication data set, the authentication processor 121 performs the first authentication process and the second authentication process according to the priority until the authentication processor 121 succeeds in booting.

The foregoing processes make it possible to take into consideration not only whether or not the EFI driver and the OS driver are valid, but also where the slot location is. Accordingly, wrong devices are not allowed to activate the operating system.

The following five problems are assumed to arise in a case where the method of the embodiment is not used; but the use of the method of the embodiment makes it to overcome these problems.

(1) An EFI driver and an OS loader are supposed to be authenticated using the associated authentication keys in the NVRAM when secure boot is enabled. In reality, however, the EFI drivers of all the PCI cards, as well as the OS loaders of the Redhat Linux (Registered Trademark) OS, the SUSE Linux OS and the like may be authenticated using the authentication key in the form of a public key offered by Microsoft (Registered Trademark). As a result, although the EFI drivers and OS loaders having been tampered with are disabled from being executed, there is a problem that if a third party loads an image of an OS which may be activated using the key offered by Microsoft in a DVD or the like, the third party may activate the OS using the thus-loaded DVD or the like. Moreover, there is likelihood that the maintenance specialist mistakenly activates the business OS instead of executing the maintenance tool.

(2) The problems with secure boot raised in (1) would be countered, if the server administrator could create hash values from a specific EFI driver and a specific OS loader, registered the thus-created hash values as the authentication keys to the DB, and thereby made only the specific EFI driver and the specific OS loader executable. In reality, however, the server administrator may select no specific EFI driver or no specific OS loader because the vendor rarely offers the EFI driver and the OS loader.

(3) When secure boot is enabled, whether or not the authentication may be performed is determined using the digital signatures or hash values of the EFI driver and the OS loader. Since information on the location of the PCI card is not used for the determination the problem raised in (2) might be solved. However, the server administrator still may not activate the OS only from the PCI card inserted in the location, which is arbitrary.

(4) There is a server which offers a function of invalidating a DVD or a specific PCI card in a case where the OS is prohibited from being activated from the device. However, if the function is used once, the device will be no longer usable after the OS activation. In addition, there is likelihood that the hardware specification makes it impossible to invalidate the device.

(5) As described above, in a usual server, the EFI driver initializes all the inserted PCI cards. After initializing the PCI cards, the EFI driver adds menus for setting the PCI cards to the BIOS menu. The setting is performed for each PCI card port. For this reason, the setting menus to be added to the BIOS menu are as many as the ports. Since the setting menu is displayed for each card port, a server with many PCI cards inserted therein clutters the setting screen with menus for setting the PCI cards which are displayed on the setting screen albeit unnecessary for the activation. For example, 80 setting menus are registered in the BIOS when 20 network controllers each with four ports are installed in the server.

The foregoing descriptions have been provided for the embodiment. The embodiment is not the only one. For example, there is a case where the functional block configuration of the above-described administrative controller 10 does not coincide with the actual program module configuration.

Furthermore, the configurations of the respective tables discussed above are examples. The tables do not have to have the configurations discussed above. In addition, as for the process flow, the process sequence may be changed if the process results remain unchanged. Moreover, the processes may be performed in parallel.

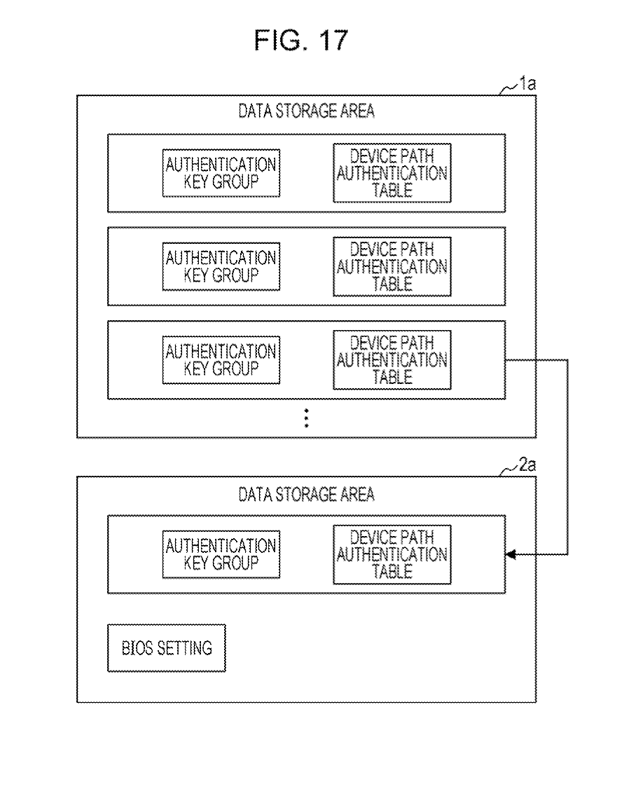

The employment of the above-described configurations would otherwise request BIOS settings to be prepared respectively in the authentication data set storages 1d to 3d. However, for example, as illustrated in FIG. 17, a data storage area 1a, and a data storage area 2a are set on the NVRAM 152. Multiple sets each consisting of an authentication key group and a device path authentication table are stored in the data storage area 1a, while one BIOS setting and one set to be outputted to the BIOS 120 are stored in the data storage area 2a. The set to be outputted to the BIOS 120 is updated. This scheme requests only one BIOS setting to be prepared, and accordingly may save an area of the NVRAM 152.

In addition, in a case where the information specifying a PCI slot is not received from the administrator, the authentication data set may include no device path authentication table.

The embodiment discussed above may be summarized as follows.

An information processing apparatus of a first aspect of the embodiment includes: (A) a data storage configured to store identification information on authentication data in association with location information on a slot, the authentication data being for determining the validity of a first program for initializing an extension card in the slot, and the validity of a second program which is stored in a storage coupled to the extension card and is for initializing an operating system; and (B) an authenticator configured to identify the authentication data using first identification information stored in the data storage in association with the location information on a first slot specified as chosen, and to determine whether or not the first program read from a first extension card in the first slot, and the second program read from a first storage coupled to the first extension card are valid using the authentication data.

The information processing apparatus is capable of taking into consideration not only whether or not the first program and the second program are valid, but also where the location on the slot is. Accordingly, the information processing apparatus is capable of disabling the operating system from being activated from wrong storages.

Furthermore, the above-described authentication data may include: first authentication data for determining the validity of the first program read from the first extension card; and second authentication data for determining the validity of the second program read from the first storage. In addition, (b1) in a case where the authenticator determines that the first program read from the first extension card is valid using the first authentication data, the authenticator may determine the validity of the second program read from the first storage using the second authentication data. Thereby, it is possible to appropriately determine the validities of the first program and the second program.

The information processing apparatus may further include (C) a display processor configured to, upon receipt of input of login information, display data on a first screen for prompting a user to create an activation method, or a second screen for receiving information specifying an activation method, on a display device depending on a user type identified by data included in the login information. Thereby, it is possible to allow the user to create or specify the activation method.

The information processing apparatus may further include (D) a first receiver configured to, upon receipt of information specifying a location of a slot, an extension card type and a type of the operating system from the user having confirmed the data on the first screen, store the identification information on the authentication data into the data storage in association with the location information on the slot specified, the authentication data being for determining the validity of the first program read from the specified extension card, and the validity of the second program for activating the specified operating system.

The information processing apparatus may further include (E) a second receiver configured to receive information specifying a location of the first slot, a type of the extension card inserted in the first slot, and a type of the operating system from the user having confirmed the data on the second screen. Thereby, the information processing apparatus is capable of being activated using the activation method specified by the user.

An authentication method of a second aspect of the embodiment includes processes of: (F) in a data storage configured to store identification information on authentication data in association with location information on a slot, the authentication data being for determining the validity of a first program for initializing an extension card in the slot, and the validity of a second program which is stored in a storage coupled to the extension card and is for initializing an operating system, identifying the authentication data using first identification information stored in the data storage in association with location information on a first slot specified as chosen; and (G) determining whether or not the first program read from a first extension card in the first slot, and the second program read from a first storage coupled to the first extension card are valid using the identified authentication data.

A program for causing a processor to execute the processes of the above method may be created; and the programs are stored in a computer-readable storage medium or storage such as a flexible disk, a CD-ROM, a magneto-optical disk, a semiconductor memory or a hard disk. Incidentally, results of intermediate processes are temporarily stored in a storage such as the main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory configured to store identification information on authentication data in association with location information on a slot, the authentication data being for determining a validity of a first program for initializing an extension card in the slot, and a validity of a second program which is stored in a storage coupled to the extension card and is for initializing an operating system; and
a processor coupled to the memory and configured to execute a process comprising;
identifying the authentication data using first identification information stored in the memory in association with location information on a first slot specified as chosen, and
determining whether or not the first program, read from a first extension card in the first slot, and the second program, read from a first storage coupled to the first extension card, are valid using the authentication data.

2. The information processing apparatus according to claim 1, wherein
the authentication data includes;
first authentication data for determining the validity of the first program read from the first extension card; and
second authentication data for determining the validity of the second program read from the first storage, and
in the determining, the first program read from the first extension card is determined valid using the first authentication data, and the second program read from the first storage is determined valid using the second authentication data.

3. The information processing apparatus according to claim 1, the process further comprising
displaying on a display, upon receipt of input of login information, a first screen for prompting a user to create an activation method or a second screen for receiving information specifying an activation method, depending on a user type identified by data included in the login information.

4. The information processing apparatus according to claim 3, the process further comprising
upon receiving of information specifying a location of a slot, an extension card type, and a type of the operating system from the user having created the activation method on the first screen, storing the identification information on the authentication data into the memory in association with the location information on the slot specified.

5. The information processing apparatus according to claim 3, the process further comprising
receiving information specifying a location of the first slot, a type of the extension card inserted in the first slot, and a type of the operating system from the user having confirmed the second screen.

6. An authentication method causing a computer to execute processing comprising:
identifying, in a memory configured to store identification information on authentication data in association with location information on a slot, the authentication data being for determining the validity of a first program for initializing an extension card in the slot, and the validity of a second program which is stored in a storage coupled to the extension card and is for initializing an operating system, the authentication data using first identification information stored in the memory in association with location information on a first slot specified as chosen; and
determining whether or not the first program, read from a first extension card in the first slot, and the second program, read from a first storage coupled to the first extension card, are valid using the identified authentication data.

7. A computer-readable and non-transitory storage medium storing an authentication program causing a computer to execute processing comprising:
identifying, in a memory configured to store identification information on authentication data in association with location information on a slot, the authentication data being for determining the validity of a first program for initializing an extension card in the slot, and the validity of a second program which is stored in a storage coupled to the extension card and is for initializing an operating system, the authentication data using first identification information stored in the memory in association with location information on a first slot specified as chosen; and
determining whether or not the first program, read from a first extension card in the first slot, and the second program, read from a first storage coupled to the first extension card, are valid using the identified authentication data.
